(19) United States
(12) Patent Application Publication
(10) Pub. No.: US 2005/0091120 A1
(43) Pub. Date: Apr. 28, 2005

(54) Online gift registry service

(76) Inventor: Rod R. Auletta, Raleigh, NC (US)

Correspondence Address: LITMAN LAW OFFICES, LTD., P.O. BOX 15035 CRYSTAL CITY STATION, ARLINGTON, VA, 22215, US

(21) Appl. No.: 10/690,612

(22) Filed: Oct. 23, 2003

(51) Int. Cl. G06F 17/60

(52) U.S. Cl. 705/26

(57) ABSTRACT

An Internet based gift registry service allowing members to post events to a calendar and/or a list and create wish lists associated with those events. Members may create or join password protected gift-exchange groups, where they may share group-specific events and wish lists. Each member is provided with a personal calendar of events, which is automatically updated with group events to which the members belongs. A member may add event reminders to his/her calendar, which are viewable by all members, or private reminders viewable only by that member. Members may also exclude other groups and group members from viewing and accessing events and their associated wish lists at the time the event is entered. A message center is provided allowing members to exchange messages and a shopping forum is available for purchasing gifts online.

### BACKGROUND OF THE INVENTION

1. Field of the Invention

The present invention relates to online gift registries, and, more particularly, to a universal, online gift registry which facilitates the creation of private gift registry groups, gift lists, and online gift purchasing on a computer network. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Description of the Related Art

Selecting the right gift for a friend or loved one is often a difficult and time consuming process. Clandestine inquiries of those associated with the intended recipient may provide clues as to what they desire, but more often than not, the gift choice is left to the discretion of the buyer. A poor choice often leads to gift duplication and/or disappointment on the part of the recipient. Gift returns have thus become a common problem.

The use of gift registries is a known solution to this problem. However, most gift registries are associated with a particular retailer. The registry must therefore be set up through the retailer and gift choices are limited to merchandise carried by that particular retailer. Online registries have been developed by retailers and individuals as a centralized, easily accessible way of creating lists of desired gifts and/or registering gifts, while offering users the option of purchasing gifts online from participating retailers listed on the web site.

U.S. Patent Publication No. 2002/0143664, published on Oct. 3, 2002, describes an Internet based gift purchasing and reminder system. A user can register his/her gift idea and calendar the event for which the gift was purchased. A reminder service then reminds the user of the event at some predetermined period prior thereto and provides links to gift sites offering gifts that match the user's gift idea. This system, however, does not allow an individual to create a gift list for themselves or others which is viewable by other users. The site also does not indicate the status of a particular gift on a list (e.g., whether it has been purchased or not).

U.S. Pat. Nos. 5,754,981 and 5,774,874 issued May 19, 1998 and Jun. 30, 1998, respectively, to William J. Veeneman, describe a computerized gift registry system wherein a registrant uses a bar code scanner to scan desired gifts, which are transmitted back to a networked computer. The computer then lists and stores identifying information about the scanned gifts. Potential gift givers are then able to access the registrant's gift list and purchase any gifts that have not yet been purchased. This system, however, requires the registrant to physically go to the store to scan the bar codes of the desired gifts.

U.S. Patent Publication No. 2002/0154178, published October, 2002, discloses an online calendaring and purchasing system that allows a user to post events on a calendar, which can be shared by multiple users. Users may also form their own groups having group-specific calendars. Online purchasing and related actions can be associated with each calendared event. This web site however does not provide the user with the option of creating gift lists in connection with a particular event.

In addition, International Patent No. WO 00/39738, published on Jul. 6, 2000, describes an online gift registry service, which allows a user to create, add to, or modify a gift list. Gift lists are reviewed by gift purchasers who select a gift and order it from an online gift supplier. Once a gift is purchased the register is updated accordingly. Users, however, are unable to create their own private groups, or control which members have viewing access to a particular event or gift.

None of the above inventions and patents, taken either singly or in combination, is seen to describe the instant invention as claimed. Thus an online gift registry service solving the aforementioned problems is desired.

### SUMMARY OF THE INVENTION

The online gift registry service of the present invention is a website that allows members to enter gift ideas in a gift or wish list (the terms “gift list” and “wish list” are used synonymously in the present application) that is associated with an event, such as a birthday, wedding anniversary, holiday, or other gift-giving occasion. Every event is displayed on a user's home page, as well as their own personal calendar, and selecting that event will access its associated gift or wish list. These wish lists may then be viewed, printed, updated, and amended by any member. Gift ideas may be added to the list in such a manner that the gift idea will not be viewable by the intended recipient of the gift.

In addition, users may create their own password-protected “virtual groups.” These groups will have their own group-specific events and associated wish lists. Each group member may add a “shared” or “individual” type event for the group, and may create or update wish lists associated with that event. A group member's personal calendar automatically displays new events added by other group members. However, a user creating a new shared or individual event may optionally hide the newly added event from selected users or groups. Additionally, a member may add a private reminder to his or her own personal calendar viewable by that member only.

Any group member may also create one or more “special members” for whom wish lists can be created, but who are unable to use the service themselves. Special members may include children, pets, or computer-illiterate acquaintances or family members. Any group member can create a wish list for their special members and add gifts to the list. They can also view all updates made by other group members to the wish lists associated with their special members.

The web site will also include a shopping forum having links to affiliated retail web sites. Users who visit a gift-shopping site will be able to copy the Uniform Resource Locator (URL) link to that site or and paste it into a gift list. The gift registry site will also feature a message center, an e-mail reminder system, group chat rooms, and offers wish lists linked to events in other groups to which the member may belong, or which may be imported from such groups.

Accordingly, it is a principal object of the invention to provide the online user community, and in particular, friends and families, a more efficient means of gift giving by eliminating the guesswork involved in determining what a gift recipient wants and what others may be planning to give the recipient through an online gift registry service.

It is another object of the invention to provide an online gift registry service to improve the quality of gift giving, while reducing the overall number of gift returns.

It is another object of the invention to provide an online gift registry service that allows users to create their own gift registry groups with group-specific calendared events and group-specific wish lists.

Still another object of the invention is to provide an online gift registry service that allows users to hide calendared events from selected members of a gift registry group, while allowing other members to view them.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of an online gift registry service according to the present invention, showing the network environment in which the invention operates.

FIG. 2 is a block diagram showing the layout of web pages and links accessible through the online gift registry service web site according to the present invention.

FIG. 3 is a flow chart showing the process of using the online gift registry service according to the present invention.

FIG. 4 is an exemplary screen shot of a home page for the online gift registry website.

FIG. 5 is a partial screen shot of a member's personalized home page on the online gift registry website, the right side and bottom of the screen being truncated.

FIG. 6 is a partial screen shot of a detailed version of a member's personal calendar for an online gift registry service according to the present invention, the right side and bottom of the screen being truncated.

FIGS. 7 and 8 are screen shots of an sample event information web pages for an online gift registry service according to the present invention.

FIG. 9 is a partial screen shot of a web page showing an exemplary wish list associated with an event for an online gift registry service according to the present invention, the right side and bottom of the screen being truncated, the right side and bottom of the screen being truncated.

FIG. 10 is a screen shot of an exemplary “special members” web page for an online gift registry service according to the present invention for an online gift registry service according to the present invention.

FIG. 11 is a screen shot of an exemplary web page to join/create a group for an online gift registry service according to the present invention.

FIG. 12 is a screen shot of an exemplary event reminder web page for an online gift registry service according to the present invention.

FIG. 13 is a partial screen shot of an exemplary shopping forum web page for an online gift registry service according to the present invention, the right side of the screen being truncated.

FIG. 14 is a partial screen shot of an exemplary toolbar customization web page for an online gift registry service according to the present invention, the right side of the screen being truncated.

FIG. 15 is a screen shot of an exemplary stored links web page for an online gift registry service according to the present invention.

FIGS. 16 and 17 are partial screen shots of exemplary message center web pages for an online gift registry service according to the present invention, the right side of the screen being truncated.

FIG. 18 is a partial screen shot for an exemplary event entry web page for an online gift registry service according to the present invention, the right side of the screen being truncated.

FIG. 19 is a screen shot of an exemplary private reminder web page for an online gift registry service according to the present invention.

FIG. 20 is a partial screen shot of an exemplary events list web page for an online gift registry service according to the present invention, the right side of the screen being truncated.

Similar reference characters denote corresponding features consistently throughout the attached drawings.

### DETAILED DESCRIPTION OF THE PREFERRED EMBODIMENTS

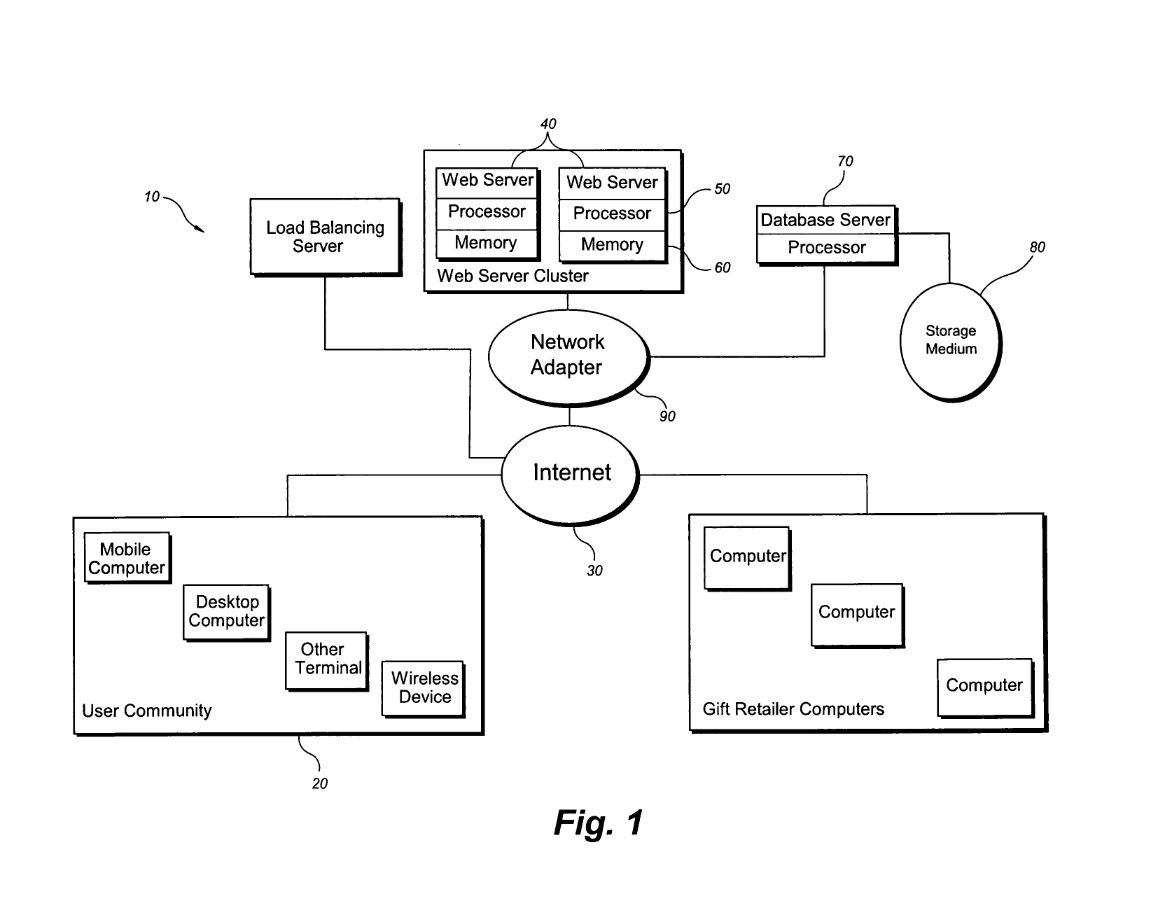

The present invention is an online gift registry service. FIG. 1 shows a block diagram of the system architecture of the service, showing the network environment in which the invention operates. The system 10 operates in a networked computing environment as shown in FIG. 1. The networked computerized system 10 uses a client-server model, including a plurality of clients 20 connected to a server 40 through a computer network, preferably the Internet 30, although the system 10 may operate on an intranet, an extranet, or another network environment. The server 40 has a processor 50 for processing instructions and an area of memory 60 for executing program code under the direction of the processor 50.

The computerized system 10 also includes at least one database 70 connected to a storage medium 80 for storing data. The database 70 may reside in an area of disk storage on the server 40 and be connected to the main memory by a bus, or may reside on a remote database server accessible by the server 40, as is known in the art. A data communication device in the form of a network adapter 90 connects the server 40 to the Internet 30. The client computers 20 have a Web browser or another network client software operable thereon for receiving and viewing documents written in Hypertext Markup Language (HTML) or another document format and transmitted over the Internet 30 via Hypertext Transfer Protocol (HTTP) by the server 40, and transmitting requests for HTML documents to the server 40 via HTTP.

The present invention includes software program code stored on a computer readable medium and operable in main memory 60 on the server 40 for providing a gift registry service, which is accessible to a client computer 20 through the Internet 30. As used in the present application, the term “computer readable medium” refers to a hard disk drive, a floppy diskette, a ZIP disk or any other magnetic storage media capable of storing coded program instructions, an optical or laser storage device, such as a compact disk or laser disk, paper tape, punch cards, or any other media for the storage of program instructions readable by a storage device or reader. The computer code may be written in Java™ (Java is a trademark of Sun Microsystems), HTML, XML, Microsoft's Active Server Pages (ASP) or any other Internet programming language known in the art, and includes code for creating and providing an online gift registry system.

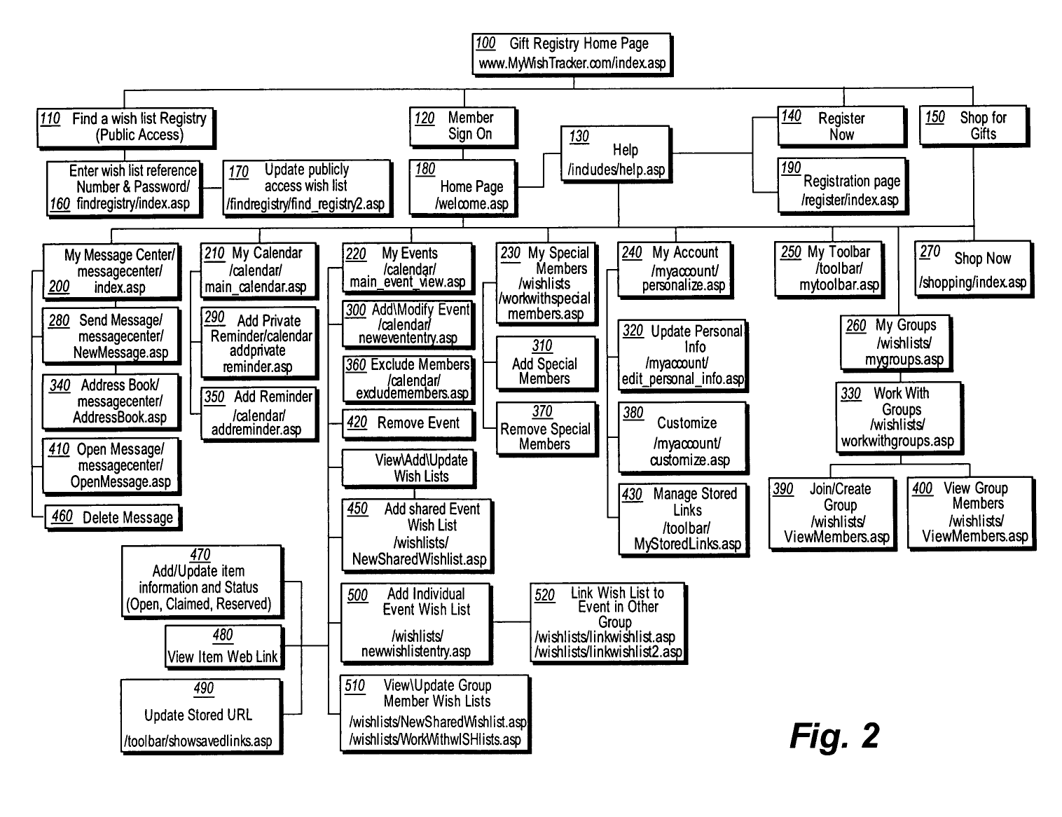

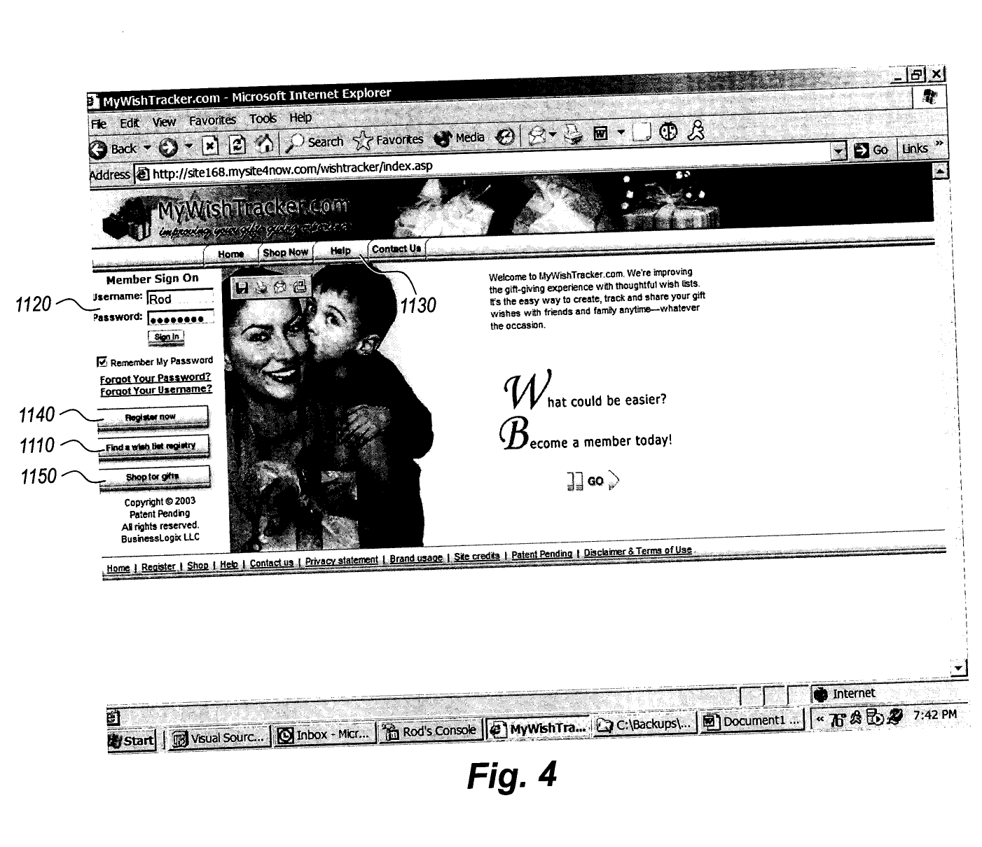

The gift registry web site, as shown in FIG. 2 comprises a home page 100 with a member sign-on field 120, a link to new member registration 140, a link to finding a gift or wish list 110, and a link to a shopping forum 150. The member sign-on 120 serves as a portal to the rest of the website, which is viewed through any Internet browser known in the art. FIGS. 4-20 depict screen shots of illustrative web pages in the website viewed through Microsoft® Internet Explorer (Microsoft and Microsoft's Internet Explorer are registered trademarks of the Microsoft Corporation of Redmond, Wash.). The Internet Explorer browser frame appearing in the screen shots is reprinted by permission from Microsoft Corporation. It will be understood that the screen shots shown in FIGS. 4-20 are exemplary only, for purposes of illustrating how the online gift registry service of the present invention may be implemented, and that specific implementations of the web pages may vary from time to time consistently with the principles of the present invention.

The gift registry home page, further depicted in FIG. 4, shows the member sign-on field 1120, and menu options in the form of hypertext links or menu buttons for: (1) registering to become a member 1140; (2) finding a particular wish list registry 1110; (3) shopping for gifts 1150; and (4) accessing a help page 1130. As shown in FIG. 2, the new user registration link 140 transfers a user to a registration page 190 where the user enters their personal account information and selects a user name and password. A drop-down menu provides a means for finding a publicly accessible wish list 110. The user may then select and access a wish list by entering the wish list reference number and password 160. Once the user accesses a selected wish list, the user can update the list 170 with new gift information.

The link to gift shopping transfers the user to a shopping forum 270, where the user is presented with a list of shopping categories. Each category contains links to participating on-line retailers who provide gifts in the listed category. Lastly, the help link transfers a user to a help page 130 with a categorical listing of help topics.

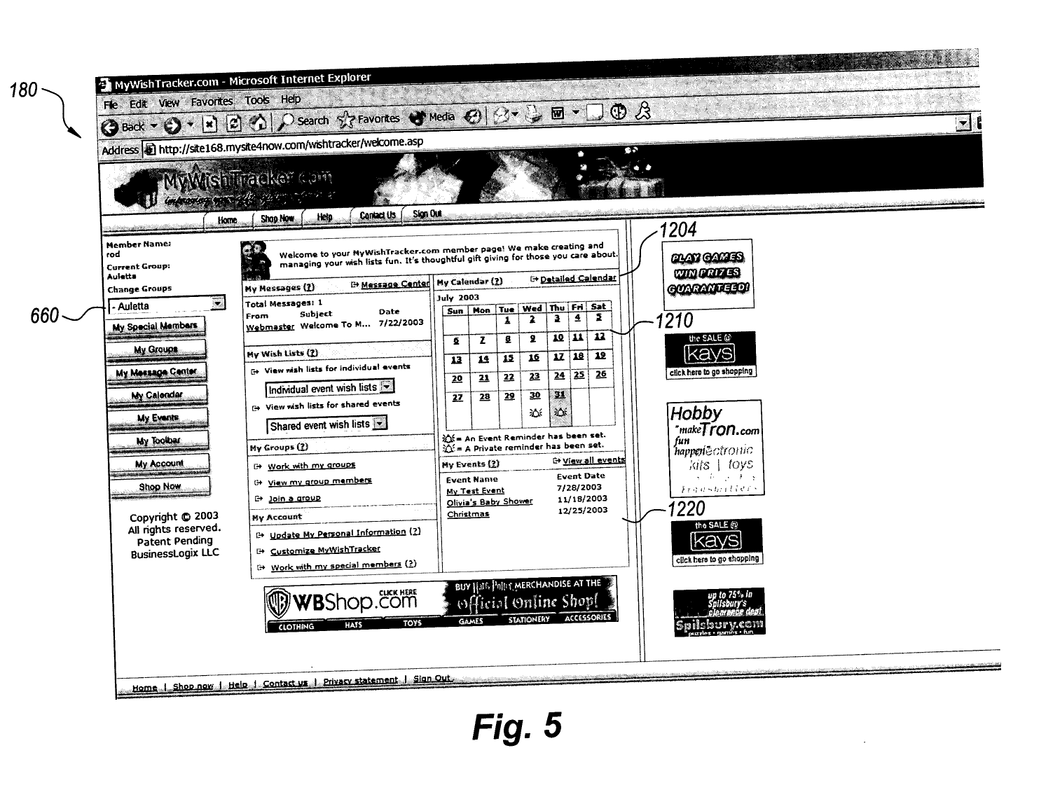

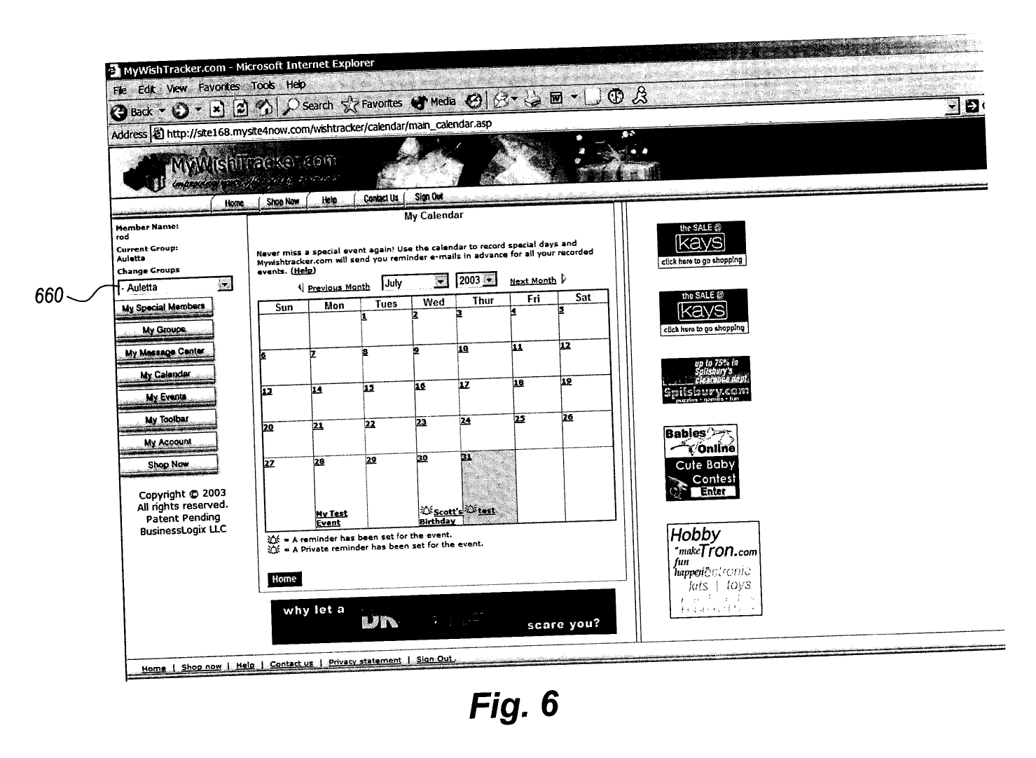

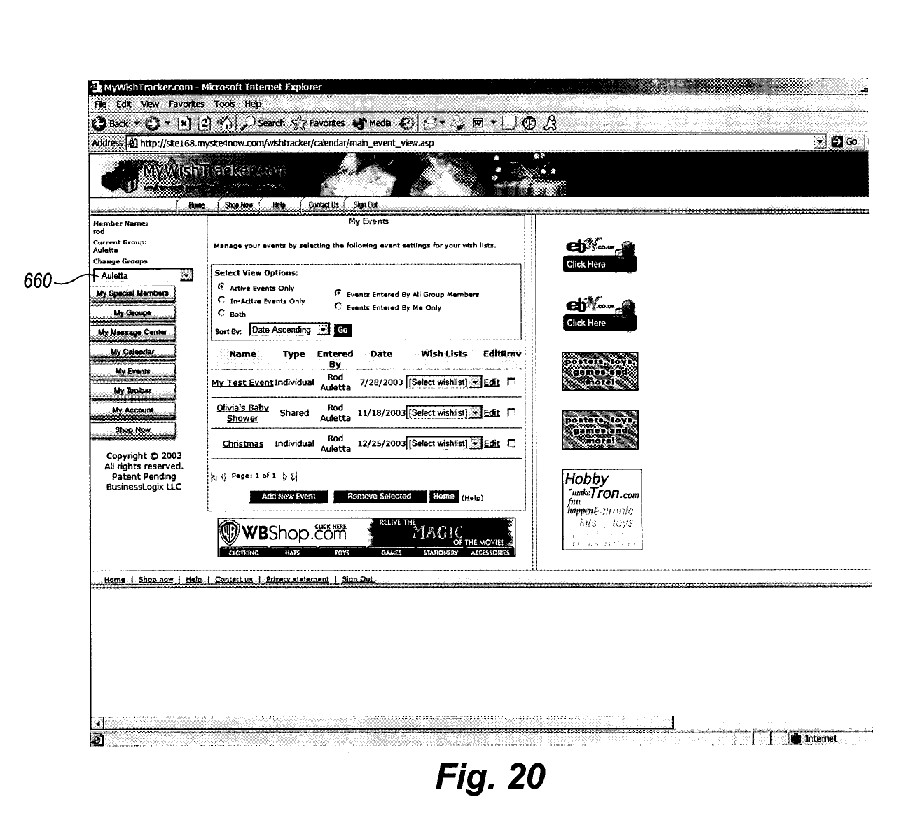

As shown in FIG. 2, once a member is registered and signed onto the site, he/she is transferred to a personal home page 180. The member's personal home page 180 includes a personal calendar of events 210, and a listing of events 220 with associated dates. In addition, a link to an events page is provided. Once the events page is accessed, a member can add new events 300 or remove events 420 previously added by that member. The member's homepage 180, shown in FIG. 5, also provides a link 1204 to a more detailed version of the personal calendar. FIG. 5 more fully illustrates the member's personal home page 180 with event calendar 1210 and event list 1220. FIG. 20 shows a member's events page and FIG. 6 shows the detailed version of a member's homepage calendar.

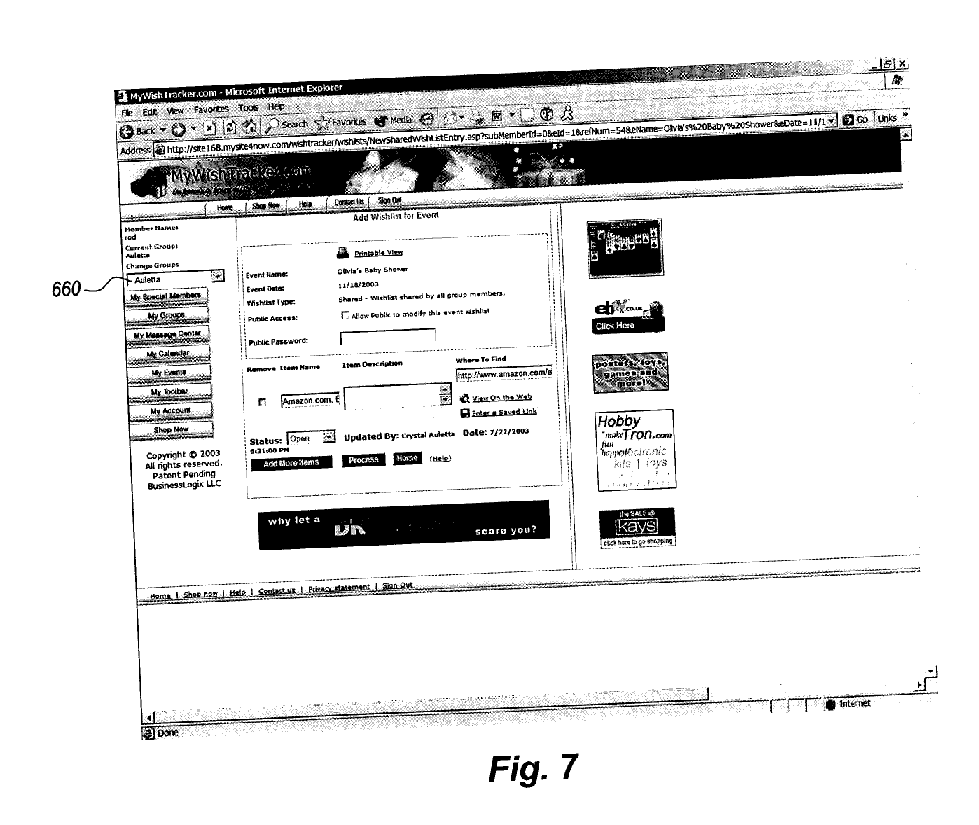

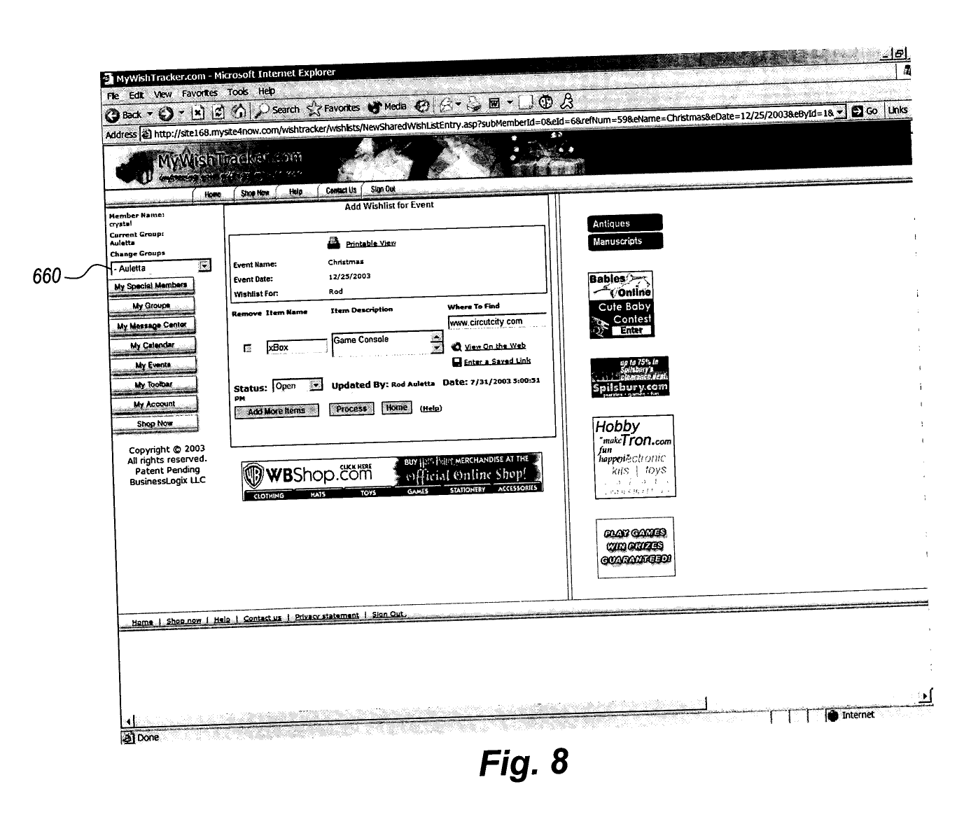

Each date having an event notated thereon includes a hyperlink, which links a user to an event information page for the date selected. Sample event information pages are shown in FIGS. 7 and 8 (not for the events shown in FIG. 6). The event information page, in turn, presents options for creating or updating one or more wish lists associated with the event by entering a new gift item in a dialog box.

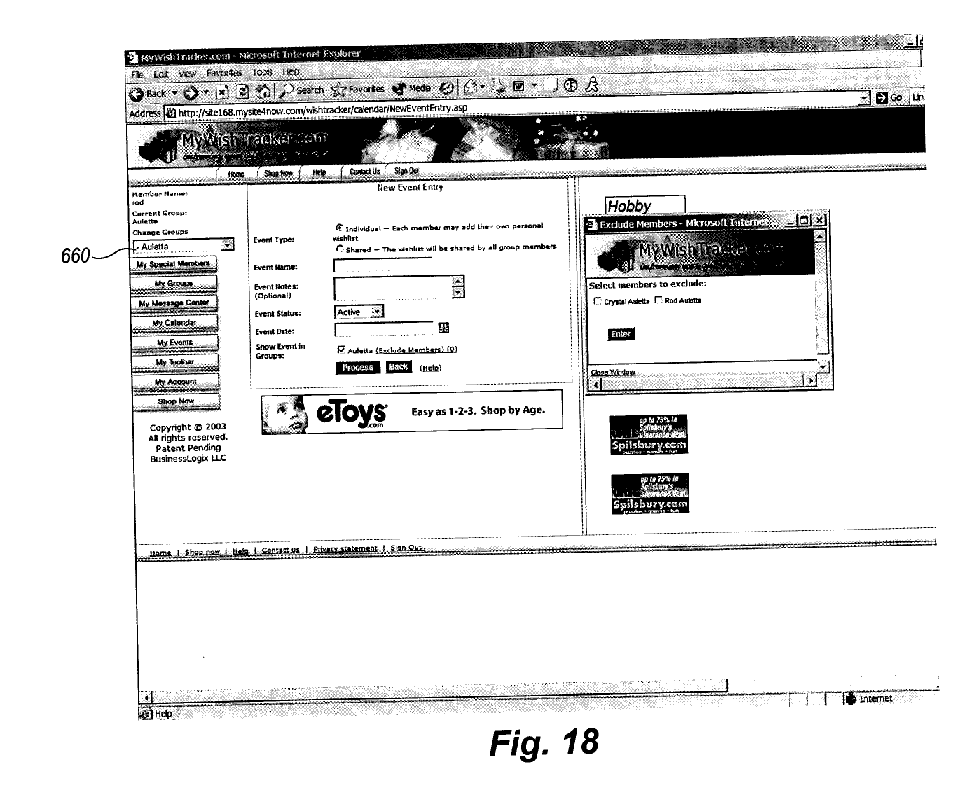

As shown in FIG. 5, a member is able to view wish lists for scheduled events by accessing a listing, such as a drop-down menu, from their personal home page. As shown in FIG. 2, two categories of wish lists may be generated based on the type of event: individual event wish lists 500 (“individual”), and shared event wish lists 450 (“shared”). An event entry page is shown in FIG. 18, which presents a member with the option of generating an individual or shared wish list by clicking the appropriate radio button. Individual wish lists are generated for events, such as Christmas, where a plurality of members can form their own personal holiday wish lists. In contrast, shared wish lists 450 are generated for events that are personal to one particular member, such as a birthday or graduation. Moreover, all members may contribute gift items to one another's individual wish lists, whereas members collectively contribute to a member's shared wish list.

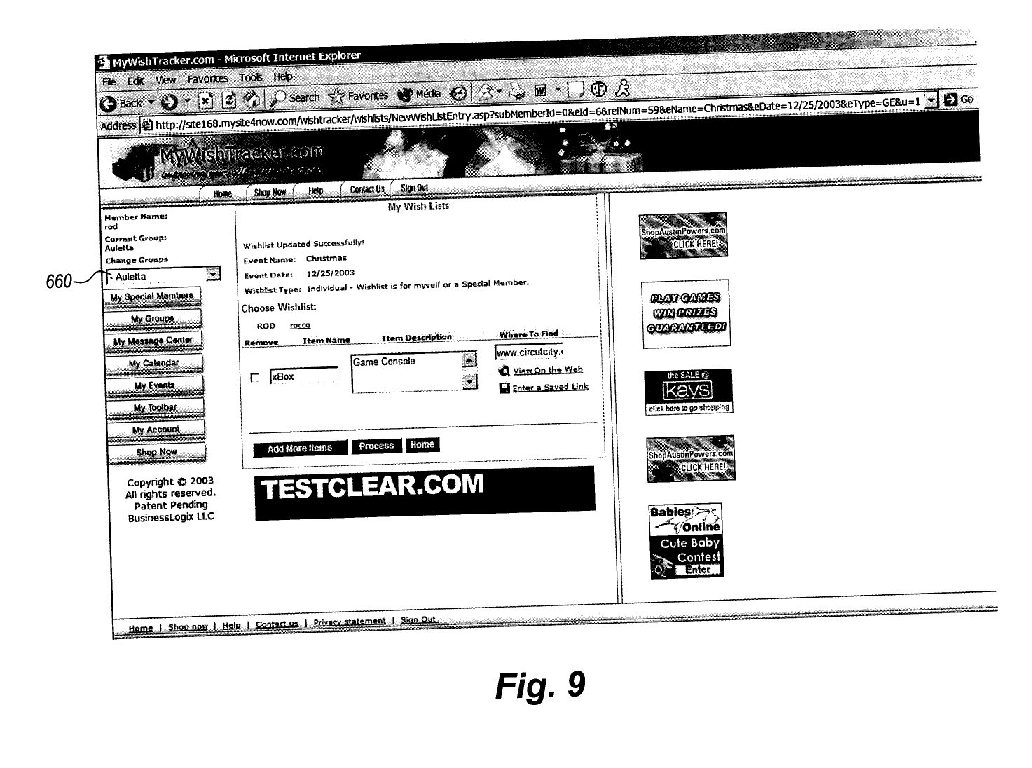

Selecting an individual or shared wish list from the drop-down menus shown in FIG. 5 directs a member to a web page, as shown in FIG. 9, showing a list of gift items, information, and options. The options available include adding new gift items, deleting gift items and/or editing gift items.

As shown in FIG. 2, any member may create, add to, or update an individual wish list for themselves, or other members 440. However, a member who creates an individual wish list for him or herself can only view and update gift ideas, which he/she has personally added. That is, gifts added by other members will be hidden from his/her view. Other members, however, are able to view all gifts added to the intended recipient's individual gift list.

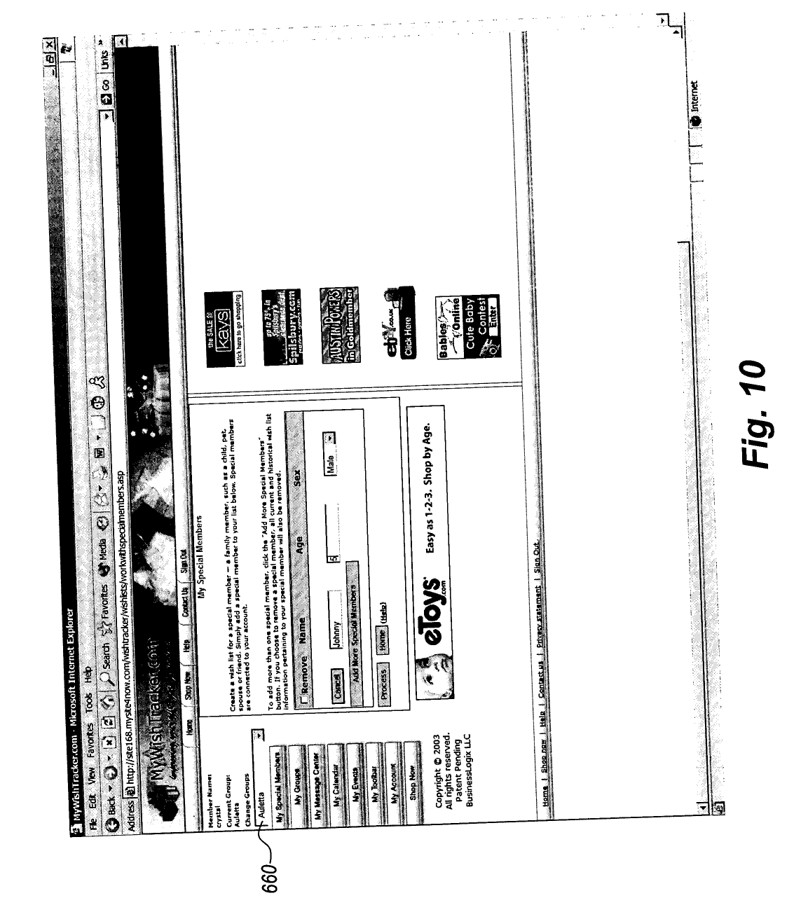

In addition, individual wish lists may be generated for “special members”, as shown in FIG. 2. “Special members” 230 are proxy members associated with a particular member, who are unable to access the website themselves (e.g. young children, pets or computer illiterate acquaintances). Any member may add 310 or remove 370 their special member, as shown in FIG. 10, and any member may generate a wish list for a special member. Furthermore, all members may add gift ideas to, or update any wish list created for, a special member.

As shown in FIG. 8, each gift added to a gift list will have information associated with it, such as gift name, description, and quantity. Furthermore, a graphical image of the gift and a link to a website with information about the gift may be provided. The status of a gift is also shown. As shown in FIG. 2, status will be indicated as “open”, “claimed” or “reserved” 470. “Open” is the default status of a gift and signifies that the gift is available for purchase. “Reserved” indicates that a member intends to purchase the gift, while “claimed,” indicates that a member has already purchased the gift. The date a gift was added and the name of the member who last updated the gift list may also be displayed as part of gift information.

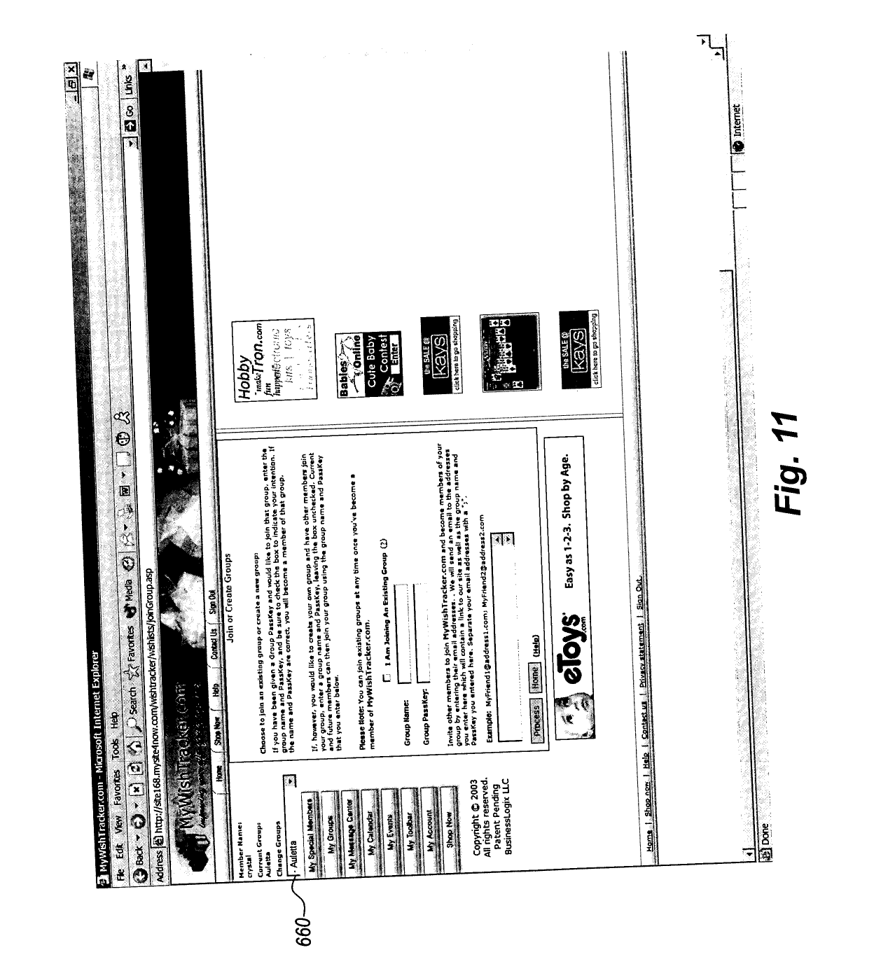

As shown in FIG. 2, members of the gift registry service may also form their own “virtual groups”, or join existing “virtual groups” 390. A virtual group is an association of members who have formed a gift-exchange group having their own group-specific web page. To join an existing group, a member must enter the group's name and password in the dialog boxes presented, as shown in FIG. 11. A password is obtained if and when an existing group member e-mails a prospective member an invitation to join the group.

As seen in FIGS. 5-12 and 14-17, once a member joins a group the group name appears in the member's group list 660, which appears on a plurality of web pages in the website. As shown in FIG. 2, a member's groups are stored in a group data file 260. To access a group's page 330 a member selects the group name from the list. Subsequently, a dialog box appears in which the member must enter the group's password. Once a member is logged into a group, he/she may access the group calendar, view and update group member wish lists 510, and view profile information for any group member 400. In addition, a group members-only chat room is available.

Members are free to join or form multiple gift registry groups, and are able to switch between their groups by selecting a group name from their group list 660. A member's personal home page is also listed in a member's group list to provide a quick and easy means of accessing their home page from anywhere in the site. Selecting a group name from the list directs a member to the corresponding group page, which resembles the member's personal home page. The group page features a calendar of events, a listing of events, a message center and a means of accessing wish lists. However, the calendar of events displayed on the group page is group-specific and the wish lists relate to group members and group events only.

When adding a group event 300, a member may select which members or groups may view the event. As shown in FIG. 2, a member indicates which, if any, member(s) or group(s) will be excluded 360 from viewing the event on their calendar (i.e. the event is hidden from them). Wish lists associated with hidden event(s) will also be hidden from the excluded members or groups. A member who sets viewing access for a new event may, at any time, modify viewing access for that event. Members who are given viewing access for an event may view and add to wish list(s) associated with that event 440. A listed gift item and its associated information, however, may only be modified or deleted by the member who originally entered the gift item.

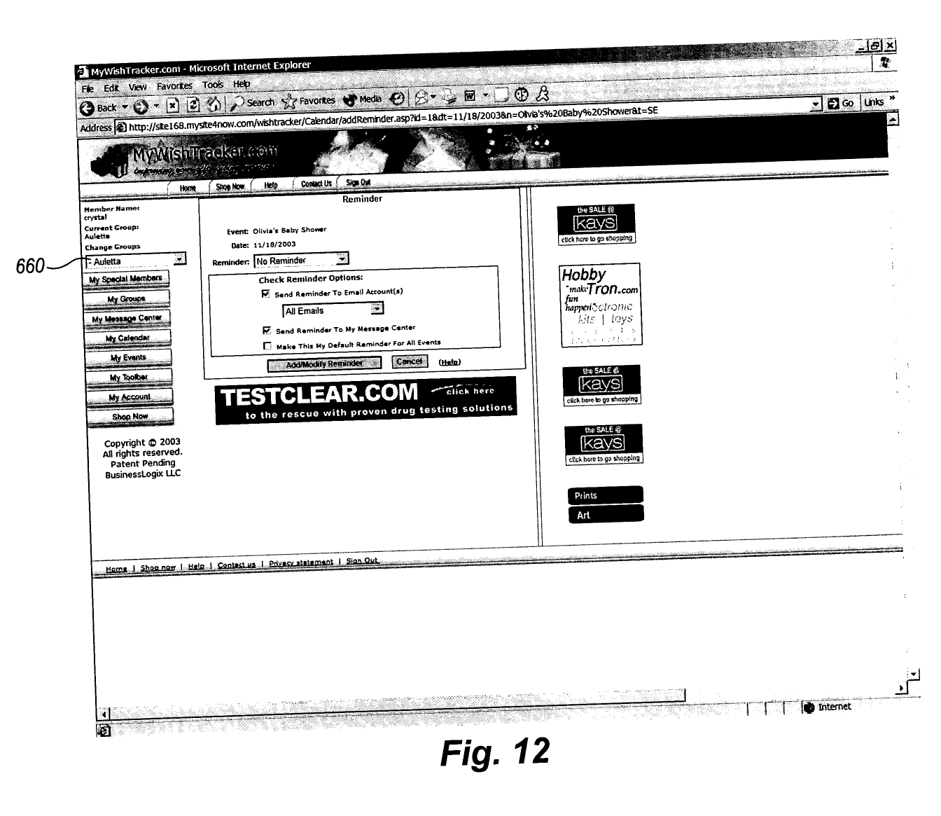

As shown in FIG. 2, an e-mail reminder 350 is optionally available to each member, which automatically notifies a member of upcoming events listed on his/her calendar. A screen shot showing how a reminder is set is depicted in FIG. 12. A member selects a calendar in order to set a reminder for that date. The member is then presented the option of setting an event reminder or a private reminder. An event reminder sends a reminder for a calendared event to a member. The member selects the method of delivery of the event reminder, which may be e-mail or a message sent to the member's message center. Additionally, a member may use the selected method of delivery for all event reminders.

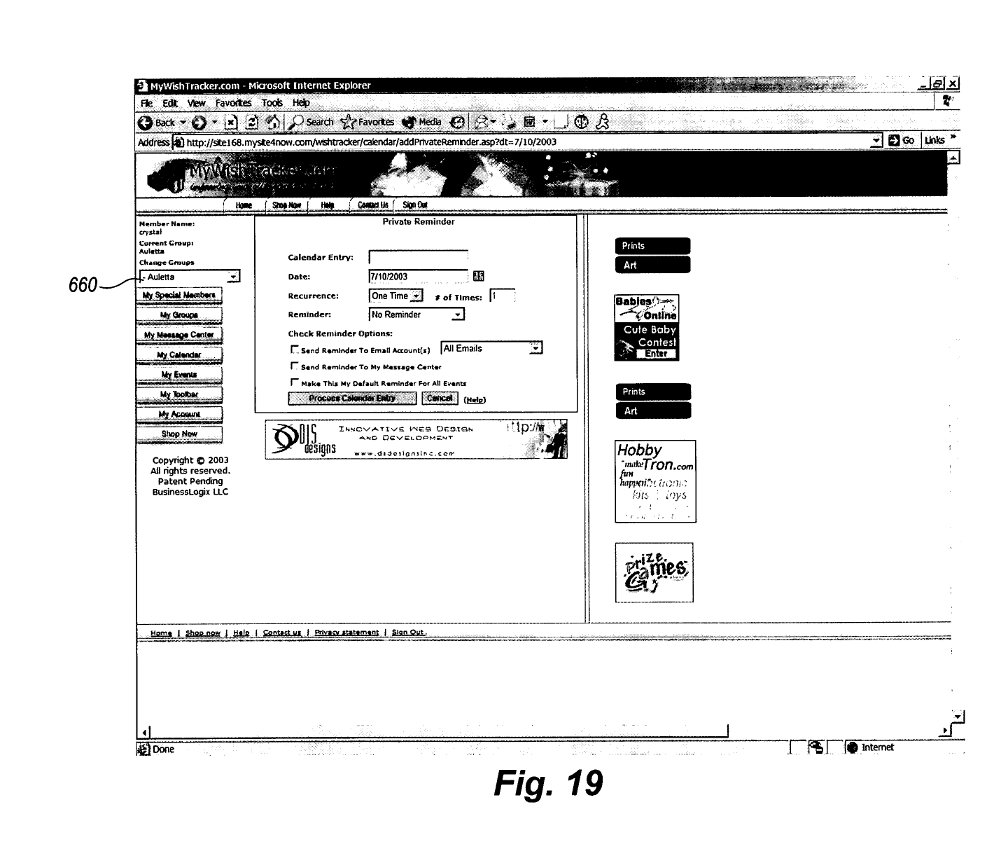

A private reminder 290 allows a member to set a reminder for any type of activity or event necessitating a reminder. As shown in FIG. 19, a member enters the activity or event information in a dialog box, which is posted to the calendar. The member then selects a method of delivery for the reminder (i.e. e-mail or message center).

For either type of reminder, a member may choose to have the reminder displayed and/or sent periodically. The member selects the frequency of the reminder (e.g. one time) from a drop-down menu on the reminder page. Once a reminder is set, a reminder icon, such as bell, is displayed on the scheduled event date on the member's calendar, as shown in FIGS. 5 and 6. Furthermore, the reminder system may be activated or deactivated at any time.

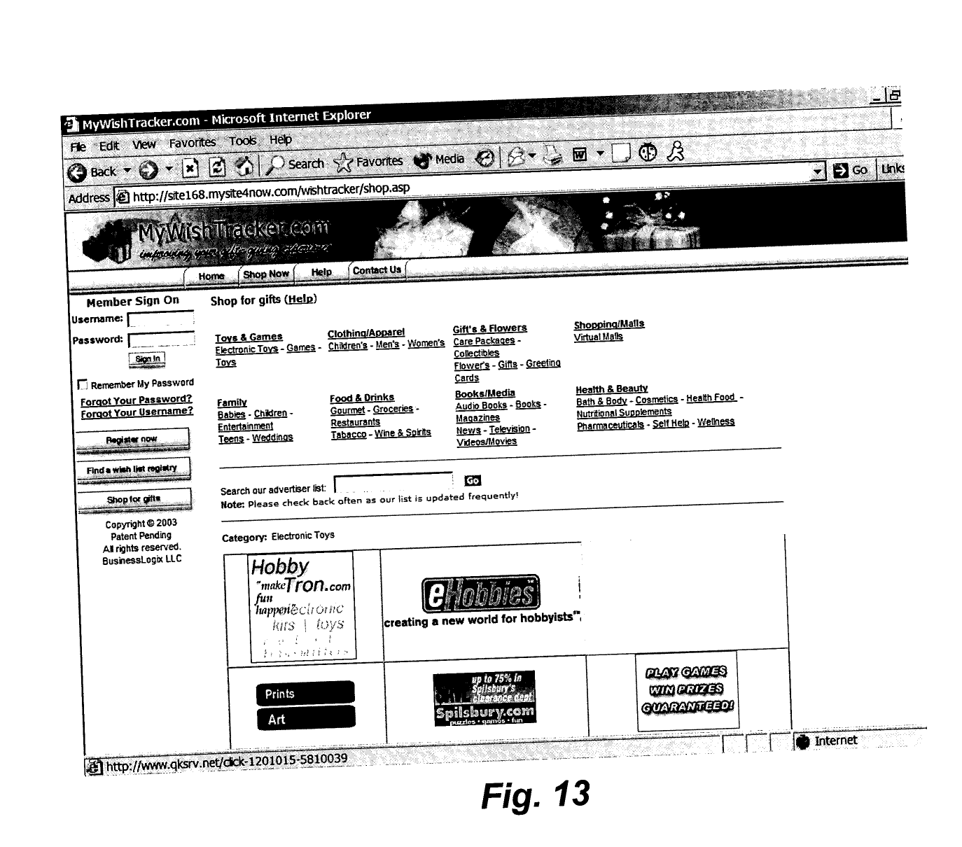

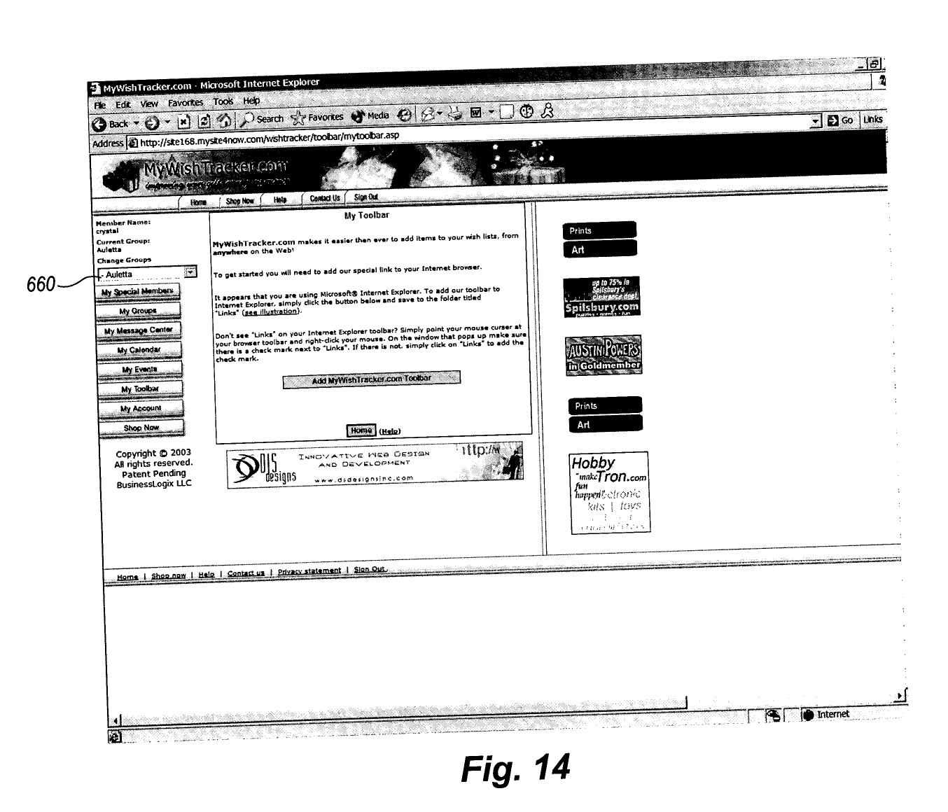

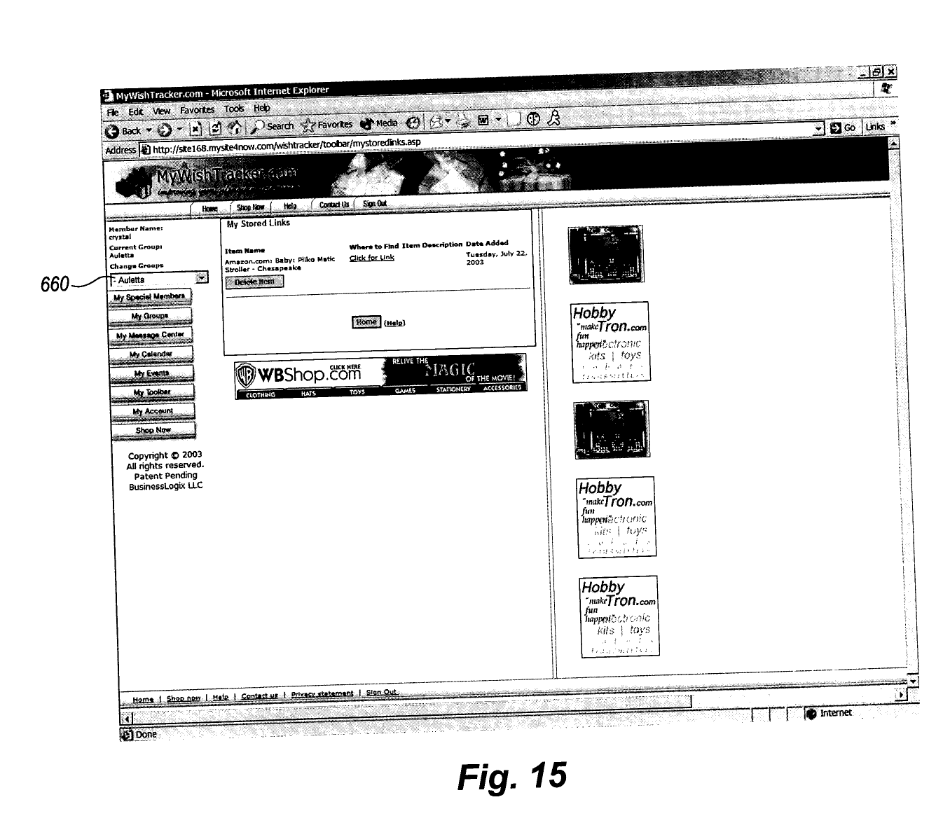

As shown in FIG. 2, an on-line shopping forum 270 is also available to users of the gift registry website. FIG. 13 shows a screen shot of the shopping forum. When the user selects the online shopping forum, he/she is presented with links to participating web retailers offering gifts in listed categories. Using a custom browser toolbar button 250, the user may copy the URL link for a website and post the URL link on a wish list for later viewing and access to the site from the wish list 480. The member creates the custom toolbar by selecting a link to the toolbar page shown in FIG. 14. The member can then customize his browser toolbar to include gift registry function buttons, such as a button for copying URLs of gift sites. A member also has the option of saving URL links to a personal data store 490 assigned to that member, as shown in FIG. 15.

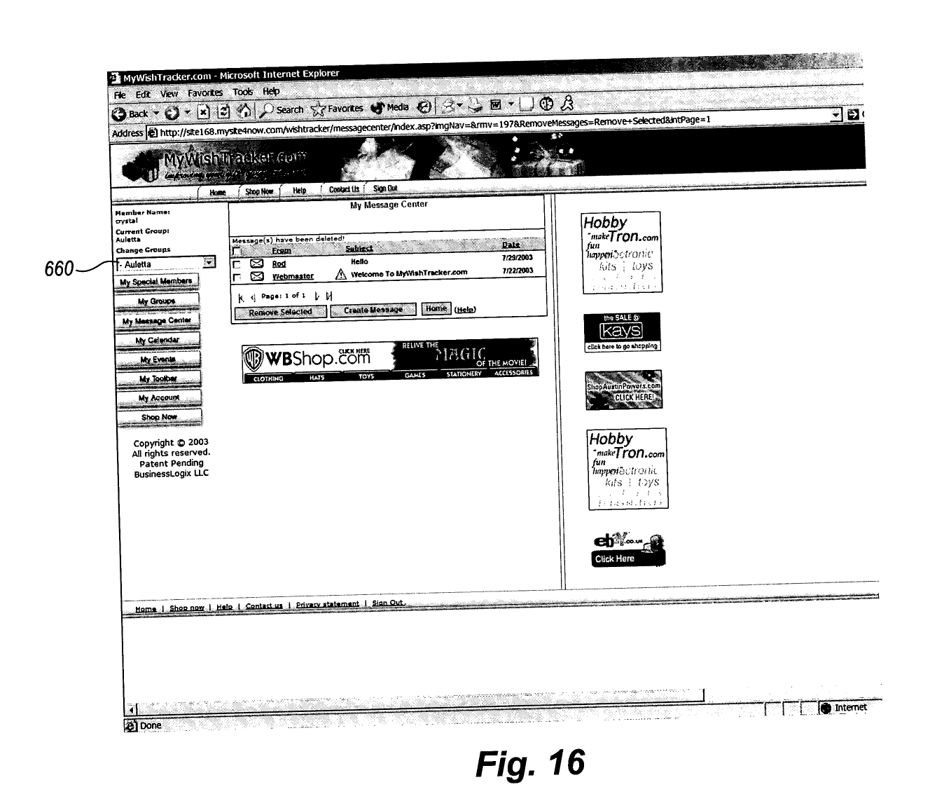

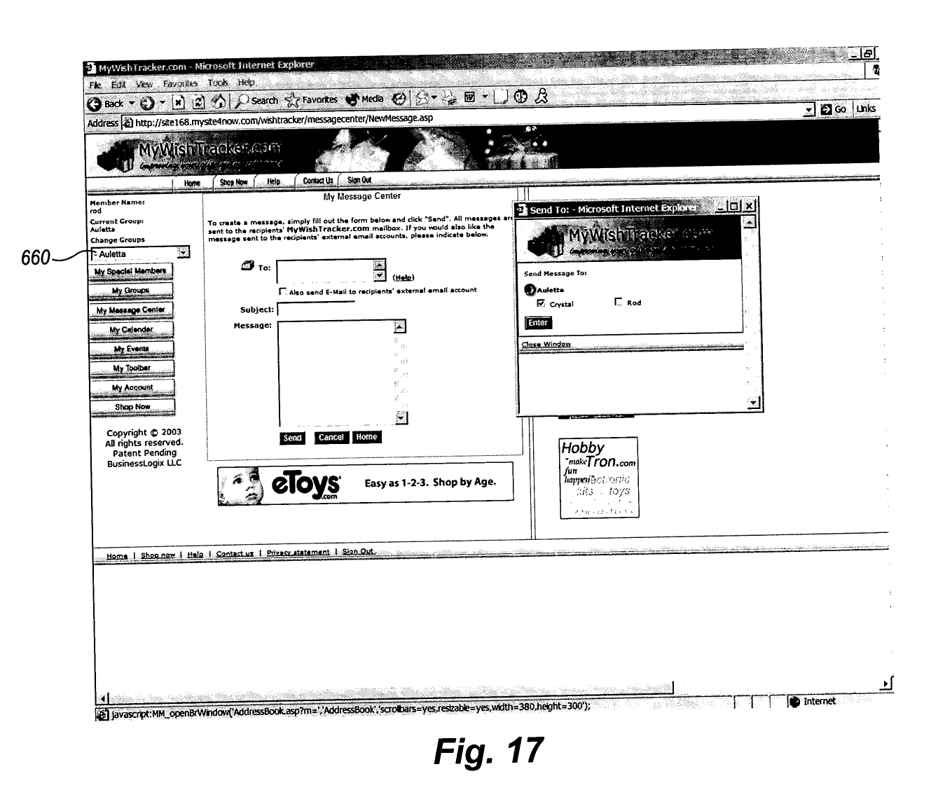

As shown in FIG. 2, the online gift registry website also features a message center 200 for transmitting and receiving messages from the “webmaster” or other members. Exemplary web pages implementing the message center are shown in FIGS. 16-17.

As shown in FIG. 2, when a user accesses the message center 200, the user is presented with options to create a new message 280, delete a message 460, or open a message 410. Electronic addresses for members of the website may be saved and retrieved from an address book 340. The message center also shows a list of messages in the member's mailbox. Selecting a message from the list opens the message. The list of messages is also displayed on a member's home page, as shown in FIG. 5, which includes information such as total number of messages in member's mailbox, sender's name, subject and date of transmission.

As shown in FIG. 2, wish lists for different groups may also be linked together 520, so that members of different groups can update a single wish list. For example, a wish list for an event called “Christmas” in group “A” may be linked to an event called “Chanukah” in group “B”. Members of either group can then update the same list. That is, any changes made to one linked list will be reflected in all linked lists. In an alternate embodiment, a member may import a wish list from one group event into another group event. Unlike the linked lists, an imported wish list remains independent and is updated separately from other wish lists associated with an event.

As shown in FIG. 2, the online gift registry website will also provide each member a means of managing their account 240. This includes updating personal information 320, customizing the viewing environment 380 and managing one's stored links file 430. Customizing the environment may include changing the color scheme or organizational layout of the website. Managing stored links includes adding to, deleting or modifying URL links in the file.

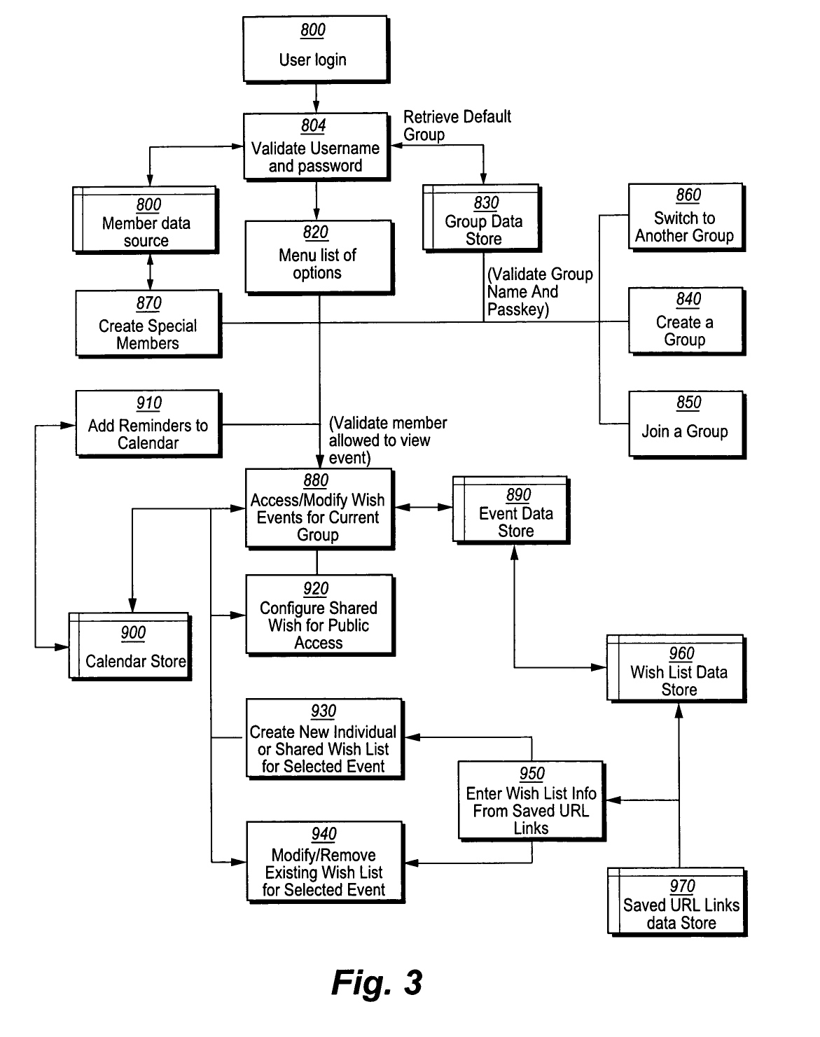

As shown in FIG. 3, a user who wishes to access the gift registry site goes to a login screen 800 and enters their user name and password. The member's username and password are validated by comparing the data entered by the user to data in the Member data store 810. Additionally, the user's group list is retrieved from the Group Data Store 830. Once the user's name and password are validated, the user is presented with a menu list of options 820. One option is to create a new group 840. When a new group is created, the group data for that group is stored in the group data store 830. Alternatively, the user may join an existing group 850 by entering the group name and group passkey associated with that group. Once a user becomes a member of multiple groups, he/she can switch between groups 860 by selecting the group from a list or menu.

Another option available to a user accessing the website is creating a “special member” 870 as described above. When a user creates a special member, special member data is transferred to the member data store 810. In addition, a user may access or modify an event for the current group 880. New events and/or changes to an event are recorded in the Event Data Store 890. In addition, any new event or change to an event is reflected in the Calendar Store 900, which contains the scheduled calendar date for each event.

Reminders may also be set 910 for any calendared event. Any new reminders are recorded in the Calendar Store 900 and are displayed when a user views a calendar or list of events. A user is given the option of making a new event accessible to all users or keeping an event private to a particular group 920. The default setting limits new event access to the current group, but allows a user to change the setting to public access.

When an event is accessed, a user is presented with the option of creating a new “individual” or “shared” wish list 930 or deleting/modifying an existing wish list for the selected event 940. Once a new wish list is created, a user can add a new wish list item and associated information to the list 950. Alternatively, the user may post a saved URL link to a website showing the wish list item on the wish list 950. The saved URL link is selected and retrieved from the Saved URL Links Data Store 970. New wish list data, including item data, is transferred to the Wish List Data Store 960. A user may also edit or delete existing information about a listed item 940, provided the user originally entered the information. Any such changes or deletions are similarly recorded in the Wish List Data Store 960.

Thus, the online gift registry service offers a convenient, computerized method of maintaining a gift list and sharing the gift list with members of a group.

It is to be understood that the present invention is not limited to the embodiments described above, but encompasses any and all embodiments within the scope of the following claims.

1. An online gift registry service, comprising:
at least one server computer having an interface for communication over a computer network, the server computer having a processor and a memory, the server further having computer software stored in the memory and executing under the direction of the processor, the computer software including:
means for publishing web pages on the network;
means for identifying individuals who have access to the service;
means for publishing event data describing an event for gift giving;
means for receiving and storing in the memory gift data entered by users describing a gift associated with a particular event;
means for publishing and maintaining calendar data identifying events for display on a user's calendar;
means for storing and publishing gift list data listing all gift ideas posted on a user's gift list; and
means for storing and publishing group data which identifies user created groups and group members in each group.

2. The online gift registry service according to claim 1, wherein said member data further comprises special member data identifying individuals without access to the service, but for whom gift lists may be generated;

3. A computerized system for generating and managing gift lists, comprising:
at least one server computer connected to a computer network;
software means residing on and operable on the server computer for publishing a plurality of web pages on the computer network, the web pages including:
link means for linking a user to online gift retailer websites for purchasing gifts;
calendar means for posting gift-giving events to a calendar accessible to a plurality of users;
gift list means for posting gift ideas to at least one dynamically created gift list associated with an event posted to the calendar;
status means for permitting gift buyers access to the gift list and to annotate a gift on the list as already purchased or reserved for purchase by the gift buyer;
group means for forming a password protected group, access to the link means, calendar means, gift list means, and status means being restricted to a member of the group.

4. The computerized system of claim 3, wherein said web pages further include:
means for restricting viewing of events posted to the calendar to selected users and groups; and
means for viewing a list of all current events and the gift lists associated with the events.

5. The computerized system of claim 3, wherein said web pages further include means for permitting group members to communicate with one another through a secure chat room accessible only to members of that particular group.

6. The computerized system of claim 3, wherein said web pages further include means for notifying members of upcoming calendared events.

7. The computerized system of claim 3, wherein said web pages further include means for permitting user profile information to be viewed by any other user.

8. The computerized system of claim 3, wherein said web pages further include means for joining multiple groups and switching between different groups.

9. The computerized system of claim 3, wherein said web pages further include means for designating special members for whom gift lists may be generated, the special members being without independent access to the system.

10. The computerized system of claim 3, wherein said web pages further include means for linking at least two of the gift lists.

11. The computerized system of claim 3, wherein said web pages further include means for importing the gift list from another group.

12. The computerized system of claim 3, wherein web pages include means for changing the status of a particular gift on the gift list to one of “open”, “claimed”, and “reserved.”

13. The computerized system of claim 3, wherein said web pages further include means for restricting viewing of events posted to the calendar to selected users and groups.

14. A method for online gift registry, comprising the steps of:
(a) publishing a website on a computer network;
(b) establishing a password protected gift registry area on the website for members of a group;
(c) providing a calendar in the gift registry area;
(d) recording a gift-giving event on the calendar; and
(e) associating a gift list created by one of the members of the group with the gift-giving event, the gift list being editable by the members of the group.

15. The method for online gift registry according to claim 14, further comprising the step of publishing a hyperlink to an online gift retailer marketing a gift recorded on the gift list.

16. The method for online gift registry according to claim 14, further comprising the step of publishing a status of a gift recorded on the gift list as purchased, unpurchased, and reserved for purchase by one of the members of the group.

17. The method for online gift registry according to claim 14, further comprising the steps of:
providing an electronic message center on the website for exchanging electronic messages between the members of the group; and
generating an electronic mail message reminder on the electronic message center of an upcoming gift-giving event.

18. The method for online gift registry according to claim 14, further comprising the step of restricting access of a member of the group to the gift list when the member creating the gift list provides for restricted access.

19. The method for online gift registry according to claim 14, further comprising the step of establishing a gift list for a non-member of the group at the request of a member of the group.

20. The method for online gift registry according to claim 14, wherein said step of providing a calendar further comprises providing both a group calendar and a personalized calendar for each of the members of the group.
